(19) United States
(12) Patent Application Publication
(10) Pub. No.: US 2023/0127202 A1
(43) Pub. Date: Apr. 27, 2023

(54) LONG-TERM PROBIOTIC BACTERIAL STORAGE AT AMBIENT TEMPERATURE

(71) Applicant: CORNELL UNIVERSITY, Ithaca, NY (US)

(72) Inventors: Alireza Abbaspourrad, Ithaca, NY (US); Seyed Mohammad Davachi, Ithaca, NY (US)

(21) Appl. No.: 17/974,134

(22) Filed: Oct. 26, 2022

Related U.S. Application Data
(60) Provisional application No. 63/272,067, filed on Oct. 26, 2021.

(51) Int. Cl. A23L 29/00

(52) U.S. Cl. CPC A23L 29/065

(57) ABSTRACT

A shelf-stable probiotic composition comprising a lyophilized probiotic dispersed in a food grade oil, wherein the probiotic in the shelf-stable probiotic composition remains viable for at least 12 months at room temperature, wherein the shelf-stable probiotic composition may further include one or more oligosaccharides dispersed in the food-grade oil. The probiotic in the shelf-stable probiotic composition may remain viable by maintaining a CFU/mL of at least 20%, for at least 12 months at room temperature, relative to a starting CFU/mL of the probiotic when first dispersed in the food-grade oil. The probiotic in the shelf-stable probiotic composition may exhibit substantially the same metabolic activity with substantially no genetic mutation after 12 months of storage at room temperature. Methods of producing the probiotic compositions are also described.

### CROSS REFERENCE TO RELATED APPLICATIONS

This application claims the benefit of priority from U.S. Provisional Application No. 63/272,067, filed on Oct. 26, 2021, which is herein incorporated by reference in its entirety.

### FIELD OF THE INVENTION

The present invention generally relates to methods for increasing the shelf life of probiotics. The present invention more particularly relates to probiotic formulations in which the probiotic remains stable and substantially viable for at least 12 months at room temperature.

### BACKGROUND OF THE INVENTION

Current probiotic formulations are generally not shelf-stable at room temperature even after only a few months. Typically, probiotic formulations of the conventional art require refrigeration to maintain their viability. Even with refrigeration, probiotic stability gradually decreases over a 12 month period. Particularly as refrigeration amounts to a substantial cost liability, and considering the limited ability of refrigeration to extend the shelf life, there would be a significant advantage in a probiotic formulation that possesses long-term stability (e.g., at least 12 months) at room temperature (typically 18-30° C., or more typically 20-25° C.).

### SUMMARY OF THE INVENTION

In a first aspect, the present disclosure is directed to a substantially more shelf-stable probiotic composition than known in the art. The shelf-stable probiotic composition contains a lyophilized probiotic dispersed in a food grade oil, wherein the probiotic in the shelf-stable probiotic composition remains stable and viable for at least 12 months (or at least 15, 18, or 24 months) at room temperature. In some embodiments, the food grade oil in the shelf-stable probiotic composition is heat-treated food grade oil, which generally has a lower percentage of active phenolic antioxidant than in the same food grade oil not heat treated. In some embodiments, the probiotic is selected from the group consisting of Lactobacillus, Bifidobacteria, Escherichia, Bacillus, Streptococcus, Saccharomyces, and combinations thereof.

The probiotic in the shelf-stable probiotic composition remains stable and viable by maintaining a CFU/mL of at least 20%, for at least 12 months at room temperature, relative to a starting CFU/mL of the probiotic when first dispersed in the food grade oil. The probiotic in the shelf-stable probiotic composition exhibits substantially the same metabolic activity with substantially no genetic mutation after 12 months of storage at room temperature. Thus, the probiotic has substantially the same viability and observed functional abilities before and after storage. The substantial lack of genetic mutation after 12 months was confirmed by, for example, RAPD-PCR analysis, which is qualitative and showed no changes after 12 months. As further discussed below, a genome sequencing test was also performed, which is quantitative and checks genomes of the DNA. This also indicated no change after 12 months.

In some embodiments, the shelf-stable probiotic composition further includes an oligosaccharide dispersed in the food grade oil. The oligosaccharide may be, for example, a fructooligosaccharide or galactooligosaccharide. In particular embodiments, the oligosaccharide is or includes inulin. Other oligosaccharides include, for example, hemicellulose, maltodextrins, cellodextrins, dextrose, and starch.

In another aspect, the present disclosure is directed to methods of preparing the shelf-stable probiotic composition described above. A first method may include the following steps: (i) dispersing a probiotic (typically lyophilized) in a heat-treated food grade oil to form a probiotic dispersion; (ii) heating the probiotic dispersion to a temperature in a range of 30-80° C. (or, for example, 30-70° C., 30-60° C., 30-50° C., or 30-40° C.) for at least 1 minute (or more particularly, for 1-5 minutes or 1-3 minutes); and (iii) cooling the probiotic dispersion to room temperature to result in the shelf-stable probiotic composition. In some embodiments, step (iii) is practiced by non-active gradual cooling of the probiotic dispersion to room temperature. Before step (i), the heat-treated food grade oil may be prepared by heating food grade oil, without probiotic dispersed therein, at 30-80° C. for at least 15 minutes (or more particularly, for 15-45 minutes, 15-30 minutes, or 15-20 minutes). In other embodiments, instead of first heating the food grade oil alone, the probiotic is dispersed in food grade oil that has not been heat-treated, and the resulting probiotic dispersion is heated at 30-80° C. (or, for example, 30-70° C., 30-60° C., 30-50° C., or 30-40° C.) for precisely or at least 15, 20, 25, or 30 minutes to result in the shelf-stable probiotic composition. In yet other embodiments, the food grade oil is first heat-treated (and optionally cooled), as described above, followed by dispersing the probiotic in the heat-treated food grade oil (typically cooled to room temperature) to form a probiotic dispersion, without heating the probiotic dispersion. Notably, the food grade oil, after being heat treated in step (ii), generally has a lower percentage of active phenolic antioxidant than in the same food grade oil when not heat treated.

In some embodiments, step (i) further includes dispersing an oligosaccharide in the food grade oil along with the probiotic to result in the shelf-stable probiotic composition containing the oligosaccharide and probiotic dispersed in the food grade oil. As discussed above, in some embodiments, the oligosaccharide is, for example, a fructooligosaccharide or galactooligosaccharide. In particular embodiments, the oligosaccharide is or includes inulin. Other oligosaccharides include, for example, hemicellulose, maltodextrins, cellodextrins, dextrose, and starch.

An alternative method may include the following steps: heating food grade oil at 30-80° C. (or, for example, 30-70° C., 30-60° C., 30-50° C., or 30-40° C.) for at least 15 minutes; dispersing a probiotic in the heated food grade oil to form a probiotic dispersion; incubating the probiotic dispersion at a temperature of 30-80° C. (or, for example, 30-70° C., 30-60° C., 30-50° C., or 30-40° C.) for at least 1 minute (or more particularly, for 1-5 minutes or 1-3 minutes); and cooling the probiotic dispersion to room temperature to result in the shelf-stable probiotic composition. In some embodiments, the cooling is or includes non-active gradual cooling of the probiotic dispersion to room temperature. In some embodiments, the method further includes dispersing an oligosaccharide in the food grade oil along with the probiotic to result in the shelf-stable probiotic composition containing the oligosaccharide and probiotic dispersed in the food grade oil. The oligosaccharide may be, for example, a fructooligosaccharide or galactooligosaccharide, or more particularly, inulin. The probiotic may be selected from the group consisting of Lactobacillus, Bifidobacteria, Escherichia, Bacillus, Streptococcus, Saccharomyces, and combinations thereof.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIGS. 1A-1B. FIG. 1A shows a typical experimental set-up for the heat treatment of probiotic LGG in oil. FIG. 1B are photographs of LGG dispersed in different oils and PBS 7.4.

FIGS. 2A-2B. Bioscreen growth curves of the probiotic bacteria stored in different oils with 75° C. heat treatment under aerobic conditions (FIG. 2A) and anaerobic conditions (FIG. 2B).

FIGS. 3A-3H. FIG. 3A shows RAPD-PCR results of the probiotic bacteria stored in representative oils after 6 months, control sample and negative E. coli sample in different RAPD primers 1254, 1281, 1290, 1283, and 1247. FIGS. 3B-3H shows RAPD 1254 primer results for different conditions: room temperature (RT) (FIG. 3B), 50° C. (FIG. 3C), 60° C. (FIG. 3D), 75° C. (FIG. 3E), RTI (FIG. 3F), RTI-60 (FIG. 3G), and RTI-75 (FIG. 3H), wherein “RTI” is prebiotic without heat treatment, “RTI-60” is inulin (prebiotic) with heat treatment at 60° C., and “RTI-75” is inulin (prebiotic) with heat treatment at 75° C.

FIGS. 4A-4B. Motility (FIG. 4A) and gram staining (FIG. 4B) test results for representative bacteria Control and Palm75 (LGG stored in palm oil with 75° C. heat treatment) after 12 months.

FIGS. 5A-5F. Micrographs showing macrophage-like cell line J774 in the presence of LGG at different time points: initial (FIG. 5A), after 8 hours (FIG. 5B), after 16 hours (FIG. 5C), and after 24 hours (FIG. 5D). Graphs showing cytokine production by J774 cells after exposure to LGG TNF- α (FIG. 5E) and IL-10 (FIG. 5F). Reported values are shown as the mean (n = 3) ± SD. For each set of measurements collected on the same day, different letters (a,b,c) within those days indicate a significant difference (a > b > c; p < 0.05).

### DETAILED DESCRIPTION OF THE INVENTION

In a first aspect, the present disclosure is directed to a shelf-stable probiotic composition containing exclusively or at least the following two components: lyophilized probiotic and food grade oil, wherein the probiotic is dispersed in the food grade oil. In some embodiments, the probiotic is homogeneously dispersed in the food grade oil. The term “dispersed” or “homogeneously dispersed” indicates that the probiotic is microscopically distributed throughout the food grade oil, typically as micron-sized particles or aggregates, e.g., an average particle size of 1-500 microns, wherein the micron-sized particles or aggregates may be substantially varied in size (e.g., ±50 or ±100 microns from an average size) or substantially uniform in size (e.g., ± 20, ±10, or ±5 microns from an average size).

The food grade oil can be any of the food grade oils known in the art. The food grade oil may be for human or animal consumption. The food grade oil may contain, for example, a mono-, di-, or tri-glyceride, or combination thereof, and may be, for example, a plant or animal derived oil. Some examples of plant oils include coconut oil, olive oil (e.g., extra virgin olive oil), almond oil, avocado oil, corn oil, cottonseed oil, flax seed oil, sesame seed oil, walnut oil, soybean oil, safflower oil, sunflower oil, palm oil, palm kernel oil, hemp seed oil, grape seed oil, canola oil, rapeseed oil, lemon oil, cocoa butter, and orange oil, any of which may be refined or unrefined. The food grade oil may also be an artificial food grade oil, such as mineral oil or a fatty acid-substituted sugar (e.g., olestra). The food grade oil may also be a fish, krill, or algal oil, which are typically high in omega-3 fatty acids. In some embodiments, any one or more of the foregoing types of oils may be excluded from the composition. In some embodiments, the food grade oil is heat-treated food grade oil (e.g., food grade oil that has been heat-treated at 30-80° C. for at least 15 minutes). Generally, food grade oil that has been heat treated has a lower percentage of active phenolic antioxidant than in the same food grade oil that has not been heat treated. In other embodiments, the food grade oil is not heat treated. Preferably, the oil has a low moisture content, preferably no more than or less than 0.3, 0.2, 0.1, 0.05, 0.02, or 0.01% of water.

The probiotic can be any of the probiotic species known in the art permissible for human consumption. According to the Food and Agriculture Organization of the United Nations (FAO) and the World Health Organization (WHO), probiotics are living microorganisms giving benefits out to the host once they reach sufficient numbers (Hemarajata & Versalovic, Therapeutic Advances in Gastroenterology, 6(1), 39-51, 2013). In some embodiments, the probiotics that may be included in the shelf-stable composition include lactic acid bacteria (LAB), which may be rod-shaped or spherical. For purposes of the present invention, the probiotic is lyophilized, i.e., freeze-dried or cryodesiccated.

Some examples of lactic acid bacteria include the following: Lactobacillus, Bifidobacteria, Escherichia, Bacillus, Streptococcus, Saccharomyces, Leuconostoc, Lactococcus, and Pediococcus, any species of which may be included in the shelf-stable composition. In some embodiments, the probiotic includes one or more species of the genus Lactobacillus. Some examples of species of Lactobacillus that may be included in the shelf-stable composition include Lactobacillus rhamnosus, Lactobacillus plantarum, Lactobacillus acidophilus, Lactobacillus reuteri, Lactobacillus delbrueckii, Lactobacillus brevis, Lactobacillus paraplantarum, Lactobacillus casei, Lactobacillus paracasei, Lactobacillus coryniformis, Lactobacillus helveticus, and Lactobacillus kefiranofaciens, any one or more which may be included in the shelf-stable composition. Other probiotic species that may be included in the shelf-stable composition include, for example, Leuconostoc mesenteroides, Bacillus coagulans, Saccharomyces boulardii, Pediococcus pentosaceus, Leuconostoc citreum, Leuconostoc argentinum, Bifidobacterium bifidum, Streptococcus thermophilus, Lactococcus lactis, Acetobacter pasteurianus, and Acetobacter aceti. In some embodiments, a combination of precisely or at least one, two, three, or more of any of the foregoing genera and/or species of probiotic is included in the shelf-stable composition. In other embodiments, one or more of any of the foregoing genera and/or species of probiotic is excluded from the shelf-stable composition.

In some embodiments, the shelf-stable probiotic composition further includes one or more oligosaccharide(s) or polysaccharide(s) dispersed in the food grade oil. The oligosaccharide or polysaccharide may be, for example, a fructooligosaccharide or galactooligosaccharide. In some embodiments, the oligosaccharide or polysaccharide is or includes inulin. In other embodiments, the oligosaccharide or polysaccharide may be, for example, chitosan, carboxymethylcellulose, dextran, pectin, guar gum, xanthan gum, locust bean gum, gum arabic, or carrageenan, or a combination thereof, or any of the foregoing in combination with inulin.

The composition preferably exhibits a probiotic viability of at least 4.0 log CFU/g after 21 days at room temperature. In different embodiments, the composition has a probiotic viability of at least 4.0 log CFU/g, 4.5 log CFU/g, 5.0 log CFU/g, 5.5 log CFU/g, 6.0 log CFU/g, 6.5 log CFU/g, 7.0 log CFU/g, or 7.5 log CFU/g, or a probiotic viability within a range bounded by any two of the foregoing values (e.g., 4.0-7.5 log CFU/g, 5.0-7.5 log CFU/g, 6.0-7.5 log CFU/g, 6.5-7.5 log CFU/g, or 7.0-7.5 log CFU/g).

The probiotic in the shelf-stable probiotic composition remains viable for at least or more than 6, 9, 12, 18, or 24 months at room temperature (typically, about 18-30° C., 20-30° C., or about 20, 25, or 30° C.). In some embodiments, the composition maintains a probiotic concentration of at least 10⁷, 10⁸, 10⁹, or 10¹⁰ CFU/ml, or a probiotic concentration within a range bounded by any two of these values, e.g., 10⁷-10¹⁰ CFU/ml, 10⁸-10¹⁰ CFU/ml, 10⁹-10¹⁰ CFU/ml, 10⁷-10⁹ CFU/ml, or 10⁸ - 10⁹ CFU/ml, for at least or more than 6, 9, 12, 18, or 24 months. In some embodiments, the probiotic in the shelf-stable probiotic composition remains viable by maintaining a CFU/mL of at least or greater than 20%, 30%, 40%, 50%, 60%, 70%, 80%, 90%, or 95% for at least or more than 6, 9, 12, 18, or 24 months at room temperature, relative to a starting CFU/mL of the probiotic when first dispersed in the food grade oil. In some embodiments, the probiotic in the shelf-stable probiotic composition exhibits substantially the same metabolic activity with substantially no genetic mutation after at least or more than 6, 9, 12, 18, or 24 months of storage at room temperature. The phrase “substantially the same metabolic activity” may correspond to at least or greater than 80%, 85%, 90%, or 95% of a starting metabolic activity over at least or more than 6, 9, 12, 18, or 24 months of storage at room temperature. The phrase “substantially no genetic mutation” may correspond to at least or greater than 80%, 85%, 90%, or 95% of a starting genetic profile over at least or more than 6, 9, 12, 18, or 24 months of storage at room temperature.

In another aspect, the present disclosure is directed to methods for producing any of the shelf-stable probiotic compositions described above. The methods can produce any of the shelf-stable probiotic compositions described above having any of the shelf-stability characteristics (e.g., viability, metabolic activity stability, and/or genetic mutation stability) described above. In some embodiments, the method includes exclusively or at least the following steps: (i) dispersing a probiotic in a heat-treated food grade oil to form a probiotic dispersion; (ii) heating the probiotic dispersion to a temperature in a range of 30-80° C. (or, e.g., 30-70° C., 30-60° C., 30-50° C., 30-40° C., 40-80° C., 40-70° C., 40-60° C., 40-50° C., 50-80° C., 50-70° C., 50-60° C., 60-80° C., 60-70° C., 70-80° C., or precisely or about 30, 35, 40, 45, 50, 55 60, 65, 70, 75, or 80° C., or a range bounded by any two of the foregoing values) for precisely, about, or at least 1, 2, 3, 4, 5, 10, 15, 20, or 30 minutes or an amount of time within a range between any of the foregoing values; and (iii) cooling the probiotic dispersion to room temperature to result in the shelf-stable probiotic composition. In some embodiments, step (iii) involves non-active gradual cooling of the probiotic dispersion to room temperature. Notably, the food grade oil that has been heat treated in step (ii) has a lower percentage of active phenolic antioxidant than in the same food grade oil not heat treated

In one set of embodiments, before step (i) of the method, the heat-treated food grade oil is prepared by heating food grade oil, without probiotic dispersed therein, at 30-80° C. (or a sub-range of temperature, as provided above) for at least 15, 20, 25, or 30 minutes (or range of time therein), before dispersing the probiotic in the heat-treated food grade oil. The probiotic may be dispersed in the heat-treated food grade oil while the food grade oil is still at an elevated temperature (such as any of those recited earlier above) or after the food grade oil has cooled to room temperature. In another set of embodiments, before step (i) of the method, probiotic is dispersed into food grade oil that has not been heat-treated to form a probiotic dispersion, followed by heating the probiotic dispersion at a temperature of 30-80° C. or range therein, which may be the same or separate heating step in step (ii). In either case, the probiotic may be dispersed by any of the means well known in the art for mixing or dispersing a particulate solid into a liquid phase (e.g., agitation, stirring, tumbling, vortexing, sonication, ultrasonication, combinations thereof, and the like). Moreover, the probiotic may be dispersed while the food grade oil is at any of the elevated temperatures provided above or at room temperature.

In some embodiments, step (i) further includes dispersing one or more oligosaccharide(s) or polysaccharide(s) in the food grade oil along with the probiotic to result in the shelf-stable probiotic composition comprising the oligosaccharide and probiotic dispersed in the food grade oil. The oligosaccharide or polysaccharide may be, for example, a fructooligosaccharide or galactooligosaccharide, such as any of these described earlier above. In some embodiments, the oligosaccharide or polysaccharide is or includes inulin. In other embodiments, the oligosaccharide or polysaccharide may be, for example, chitosan, carboxymethylcellulose, dextran, pectin, guar gum, xanthan gum, locust bean gum, gum arabic, or carrageenan, or a combination thereof, or any of the foregoing in combination with inulin.

In more specific embodiments, the method for preparing the shelf-stable probiotic composition includes the following steps: heating food grade oil at 30-80° C. for precisely, about, or at least 15, 20, 25, or 30 minutes (or within a range therein); dispersing a probiotic in the heated food grade oil (which may be at a temperature of 30-80° C.) to form a probiotic dispersion; incubating the probiotic dispersion at a temperature of 30-80° C. for precisely, about, or at least 1, 2, 3, 4, 5, 10, 15, 20, or 30 minutes or an amount of time within a range between any of the foregoing values; and cooling the probiotic dispersion to room temperature to result in the shelf-stable probiotic composition. The temperature in each of the 30-80° C. temperature ranges provided above are independently selected (such as provided above) and may be different or same temperatures. In some embodiments, the cooling step involves non-active gradual cooling of the probiotic dispersion to room temperature. In some embodiments, one or more oligosaccharide(s) or polysaccharide(s) is/are dispersed in the food grade oil during or after the food grade oil is heated or during or after the probiotic is dispersed in the heated food grade oil to result in the shelf-stable probiotic composition containing the oligosaccharide and probiotic dispersed in the food grade oil.

Examples have been set forth below for the purpose of illustration and to describe the best mode of the invention at the present time. However, the scope of this invention is not to be in any way limited by the examples set forth herein.

### Examples

### Overview

In this study, probiotics were heat treated at different temperatures in the presence and absence of the prebiotic (inulin) and stored in several food-grade oils with various amounts of polyunsaturated and monounsaturated fat for 12 months at room temperature. The heat-treated probiotics have the ability to actively grow to a high concentration after coming out of the oils and re-culture. To demonstrate that there is no mutation in the bacteria after 12 months, several tests were performed, including: random amplified polymorphic DNA polymerase chain reaction (RAPD-PCR); bio-screen growth; motility test; gram staining microscopy imaging antimicrobial test; inflammatory and anti-inflammatory cytokine induction tests; metabolite secretion; and DNA genome sequencing. The bacteria samples, regardless of aerobic and anaerobic conditions and treatment methods, showed no changes in their growth behavior, and the RAPD-PCR, antimicrobial, morphology, and motility tests also showed no major differences. Surprisingly, Lactobacillus rhamnosus GG (LGG) showed both inflammatory and anti-inflammatory properties, and in both instances, the sample treated with a higher concentration of antioxidant (Gal400) showed lower results when compared to the other samples. These results were confirmed by metabolite and genome sequencing studies showing that the Gal400 induced lower concentration and secretion percentages and the highest number of single nucleotide polymorphisms (SNPs). The outcome of this work illustrates that the long-term storage of the probiotic formulations described herein at room temperature has substantially no impact on probiotic activity.

### Sourcing

Food-grade oils with varying saturation levels (corn, sesame, canola, palm, cocoa butter (Cobu), coconut, hemp seed, and extra virgin olive (EVO) oils) were purchased from the local market. Probiotic strain Lactobacillus rhamnosus GG (LGG, ATCC 53103) was obtained from a commercial source as a powder. This probiotic is a Gram-positive, rod-shaped facultative anaerobic, heterofermentative, lactic acid bacteria that show optimal growth at 37° C. The murine macrophage cell line J774 was grown in RPMI 1640 supplemented with 10% fetal bovine serum (FBS). Monolayers of the cell line were kept at 37° C. with 5% CO₂.

### Sample Preparation

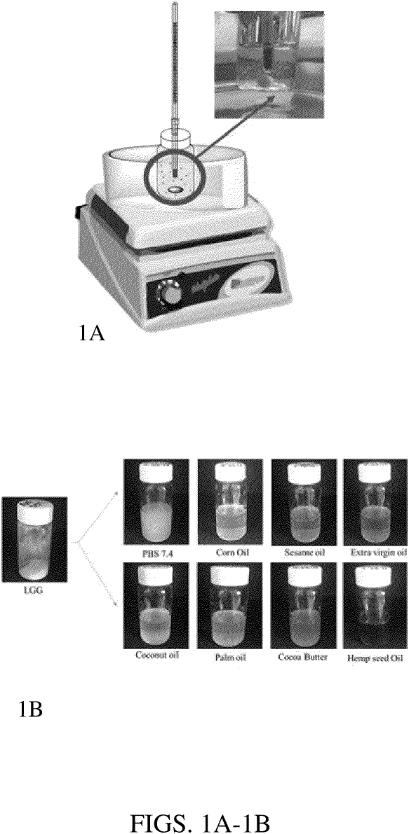

The LGG bacteria were heat-treated at 50° C., 60° C., and 75° C. using a silicon oil bath in the presence and absence of prebiotic inulin in different oils such as corn, sesame, coconut, extra virgin olive, palm and hemp seed oils, and cocoa butter. PBS at pH 7.4 was used as a control for each temperature. Each individual vial containing 20 mL of oil was heated to reach the desired temperature and the temperature equilibrated for 15-20 minutes. To each heated vial, 0.05 g of LGG powder was added. For prebiotic treatment, 0.05 g of inulin were added before the addition of LGG. The vial containing the oil-bacteria mixture was held at temperature for 1 minute with gentle stirring. Finally, the vial was taken out of the oil bath and cooled to room temperature over a range of 25 to 45 minutes depending on the heating treatments. As control samples, the LGG powder was added to each type of oil and PBS (pH 7.4) with the samples not heated. FIG. 1A illustrates the experimental set up for the heat treatment.

### Bacterial Survivability Test

To prevent bacterial growth during storage of probiotics in aqueous solutions, oil was used as a barrier to water penetration and thus serves to preserve and prevent spoilage of the probiotic products. Before the storage of bacteria in oil, the LGG concentration in each type of oil was quantified and recorded as the initial concentration. To check the viability of LGG in a variety of oils, to create a stock sample, 0.05 g of LGG powder was added to each bottle containing 20 ml of an oil, such as corn, sesame, coconut, extra virgin olive, palm and hemp seed oils, and cocoa butter. The control medium was 20 mL of PBS at pH 7.4. For the control sample, 0.05 g of the bacteria were added to PBS and, after mixing, cultured on MRS agar plates. To prepare the test solutions, 0.5 mL of each stock sample were added to separate vials containing 4.5 mL of PBS at pH 7.4. These mixtures were shaken to allow bacteria to migrate from the oil into the water phase. Then, 0.5 mL of the water phase, now containing bacteria, were cultured on MRS agar plates. The survivability of the bacteria was assessed at specific time points over a year using the colony count technique. The total count of viable bacteria was obtained as colony-forming units per mL (CFU/mL). All samples were stored at -80° C. Experimental cultures were derived from frozen stocks without subculture and grown in MRS broth or agar at 37° C. based on the required test.

### Growth Curve Analysis

Standardized growth curve analysis was used to examine the growth ability of bacteria with or without treatments. Both aerobic and anaerobic conditions were used with a Bioscreen C automated plate reader at 37° C. without shaking except for 10 seconds before optical density measurement at 600 nm (OD₆₀₀). The OD₆₀₀ was automatically recorded at an interval of 1 h for a course of 48 h incubation. LGG samples, treated with a variety of conditions, were streaked onto MRS agar and incubated overnight at 37° C. A single colony was picked from each plate to inoculate 5 mL of MRS broth, followed by incubation at 37° C. for 18 h. The overnight cultures were diluted (1 to 100) into fresh MRS broth for growth curve analysis. Bacterial growth under anaerobic conditions was conducted by covering each well with 100 µl of sterile mineral oil. All experiments were completed in triplicate and performed twice.

### Statistical Analysis

Commercial software was used to statistically evaluate the results, and the data were reported as a mean ± standard deviation using a statistic one-way ANOVA. In all the calculations, p<0.05 was deemed to be statistically significant.

### Bacterial Viability

The colony counting technique was used to evaluate the effect of temperature, prebiotic, and combination of these two after 3, 6, and 12 months of storage. FIG. 1B shows the preservation of LGG in different oils. Generally, the bacteria did not survive at room temperature in any water-based media. This may be due to the fact that the bacteria could not remain in the dormant phase, thus growing into the stationary phase. Therefore, it is important that bacteria should be kept in the media without any water. Table 1 shows the effect of heat treatment of the bacteria/oil and as can be seen, compared to the initial concentration and control sample the LGG have shown a very high concentration (CFU/mL). Table 1, section A (i.e., Table 1A) shows the results for oils that were not heat treated. In order to use almost all of the selected oils for storage of the bacteria, they were heat-treated for 15-20 minutes with different temperatures, and the temperature was optimized to have the maximum concentration of LGG in all of the oils. It can be seen that coconut and EVO oils show complete death of all the bacteria after 3 months in the untreated samples; however, heat treatment increased the concentration of LGG in these bacteria by 6 logs.

EVO oil contains phenolic compounds, such as oleuropein, hydroxytyrosol, and tyrosol and a wide range of minor polyphenols including vanillic acid, p-coumaric acid, vanillin, demethyloleuropein, homoorientin, verbascoside, rutin, luteolin glucoside, apigenin rutinoside and glucoside, luteolin, oleuropein aglycone, cyanidin glucoside and rutinoside, which all contribute to the stability of the oil and have shown antioxidant properties (B. de Roos et al., Olives Olive Oil Health Dis. Prev., Academic Press, San Diego, 2010: pp. 887-894). These phenolic compounds kill the bacteria by hydrogen peroxide generation by inducing oxidative stress in bacteria as well as by binding to cell wall components and interaction with bacterial proteins (B. A. Zullo et al., ioMed Res. Int. 2018 (2018) e8490614). Coconut oil may also contain phenolic compounds that have shown scavenging activity and antioxidant properties (A. M. Marina et al., Int. J. Food Sci. Nutr. 60 (2009) 114-123). Therefore, it can be proposed that among the samples, depending on the number of available antioxidants in the oils, the bacteria may die faster.

It is noteworthy to mention that, upon heat treatment of the oils, most of the available antioxidant in the oils was removed or deactivated, which lead to an increase in the final concentration of the bacteria even after 1 year of storage. According to the results reported in Table 1B, it can be observed that the initial concentration of the control sample dropped by 1 log upon heat treatment, while all the other bacteria stored in the oils kept the ~10⁹ concentration at 50° C. By further increasing the heat treatment temperature to 60 and 75° C. (Table 1C, 1D), the control sample showed two orders of magnitude reduction when compared to the room temperature control sample, while most of the bacteria stored in the oils showed an initial order of magnitude reduction and stayed constant after 6 to 12 months storage in oil. The bacteria have survived up to 75° C. in the oils for at least one minute, with minimum loss in their concentration. Since the oils were allowed to cool down to room temperature, it took approximately 45, 35, and 25 minutes for oils at temperatures of 75, 60, and 50° C., respectively, to cool down to room temperature.

TABLE 1

Stored probiotic bacteria in different oils without and with initial oil heat treatment at different temperatures after 3, 6, and 12 months in room temperature and effect of antioxidant on bacterial survival

| Heat Treatment | Sample | Initial | 90 Days Count | 180 Days Count | 360 Days Count |
|---|---|---|---|---|---|
| | | (CFU/mL) | (CFU/mL) | (CFU/mL) | (CFU/mL) |
| (A)RT | PBS Control | 1.40E+09 | 1.80E+01 | 0 | 0 |
| | Coconut Oil | 2.10E+09 | 4.40E+03 | 0 | 0 |
| | Sesame Oil | 2.90E+09 | 1.40E+08 | 8.00E+08 | 9.00E+08 |
| | Corn Oil | 2.10E+09 | 2.20E+08 | 2.34E+08 | 3.60E+06 |
| | Extra Virgin Olive Oil | 3.30E+09 | 3.00E+03 | 0 | 0 |
| | Cocoa Butter | 2.08E+09 | 1.00E+08 | 2.90E+07 | 1.83E+06 |
| | Palm Oil | 1.20E+09 | 4.80E+08 | 1.20E+08 | 4.20E+06 |
| | Hemp Oil | 2.30E+09 | 1.24E+08 | 9.60E+08 | 8.60E+06 |
| | Canola Oil | 1.94E+09 | 5.60E+07 | 5.60E+07 | 1.02E+06 |
| (B) 50° C. | PBS Control | 1.58E+08 | 1.80E+01 | 0 | 0 |
| | Coconut Oil | 1.56E+09 | 8.00E+08 | 3.22E+08 | 1.46E+08 |
| | Sesame Oil | 1.46E+09 | 3.20E+09 | 2.06E+09 | 5.00E+08 |
| | Corn Oil | 1.02E+09 | 2.20E+09 | 1.82E+09 | 5.20E+08 |
| | Extra Virgin Olive Oil | 1.42E+09 | 2.40E+06 | 4.40E+04 | 4.60E+04 |
| | Cocoa Butter | 1.04E+09 | 4.00E+08 | 1.00E+08 | 1.06E+06 |
| | Palm Oil | 1.00E+09 | 5.20E+08 | 2.82E+08 | 1.44E+08 |
| | Hemp Oil | 1.52E+09 | 3.00E+09 | 1.84E+09 | 7.40E+08 |
| | Canola Oil | 2.68E+09 | 1.70E+09 | 1.34E+09 | 3.20E+08 |
| (C) 60° C. | PBS Control | 1.14E+07 | 1.70E+01 | 0 | 0 |
| | Coconut Oil | 6.40E+08 | 2.14E+08 | 8.80E+08 | 3.60E+08 |
| | Sesame Oil | 9.60E+08 | 8.80E+08 | 8.20E+08 | 1.64E+08 |
| | Corn Oil | 3.74E+08 | 1.40E+08 | 3.50E+08 | 1.70E+08 |
| | Extra Virgin Olive Oil | 3.12E+08 | 2.02E+08 | 7.40E+08 | 1.00E+06 |
| | Cocoa Butter | 1.02E+09 | 3.00E+08 | 1.42E+08 | 1.44E+07 |
| | Palm Oil | 1.02E+09 | 1.76E+08 | 2.26E+08 | 1.26E+08 |
| | Hemp Oil | 7.60E+08 | 9.60E+08 | 8.20E+08 | 5.60E+08 |
| | Canola Oil | 1.22E+08 | 9.00E+08 | 8.80E+08 | 7.60E+08 |
| (D) 75° C. | PBS Control | 1.36E+07 | 1.60E+01 | 0 | 0 |
| | Coconut Oil | 1.24E+08 | 4.00E+08 | 3.40E+08 | 2.40E+07 |
| | Sesame Oil | 1.02E+08 | 1.00E+08 | 4.40E+08 | 1.02E+08 |
| | Corn Oil | 1.06E+08 | 3.00E+08 | 3.60E+08 | 1.16E+08 |
| | Extra Virgin Olive Oil | 1.22E+07 | 5.80E+07 | 1.58E+07 | 1.02E+06 |
| | Cocoa Butter | 1.04E+08 | 1.24E+08 | 4.80E+07 | 2.20E+07 |
| | Palm Oil | 4.60E+08 | 4.00E+08 | 1.88E+08 | 1.80E+08 |
| | Hemp Oil | 5.40E+08 | 3.60E+08 | 3.60E+08 | 3.80E+08 |
| | Canola Oil | 1.22E+08 | 6.60E+08 | 6.60E+08 | 3.40E+08 |
| (E) Antioxidant | Sample | Initial | 30 Days Count | 90 Days Count | 180 Days Count |
| | | (CFU/mL) | (CFU/mL) | (CFU/mL) | (CFU/mL) |
| | Gallic Acid 200 mg/L | 1.20E+09 | 2.40E+07 | 2.46E+07 | 5.60E+03 |
| | Gallic Acid 400 mg/L | 8.00E+08 | 1.34E+06 | 3.40E+05 | 0 |

The bacteria were in the oil at the peak of the temperature and then in the cooling procedure. In other words, they have been heat-treated for more than 1 minute. These results indicate that short-term treatment can deactivate the antioxidant as much as possible; however, severe heat treatment gives the antioxidants the possibility of recovery. The temperature between 60-75° C. shows the highest bacterial survival for all the oils, while at 50° C. in EVO some of the antioxidants still show activity and kill the bacteria by reducing the concentration. To confirm the effect of antioxidant activity on bacteria survival, two concentrations of Gallic acid (200 and 400 mg/L) were added into the PBS7.4 and the effect of this antioxidant on the survival of LGG was assessed.

As shown in Table 1E, the addition of Gallic acid at 400 mg/L caused a rapid reduction in live LGG cells within 1 month. After 6 months of treatment with gallic acid at 400 mg/L, there were no live bacteria cells detected. Even at lower concentrations of gallic acid, i.e., 200 mg/L, there were only 0.0005% (CFU/mL) of the bacteria alive after 6 months of treatment. Inulin also reduced the survival rates of the bacteria under all conditions.

The effect of prebiotic addition with and without heat treatment was also investigated, with the results shown in Table 2. The use of inulin (prebiotic) decreases the initial concentration of LGG by two orders of magnitude at higher temperature as the inulin acts as hot spots and can attach to the bacterial cell wall, destroying it. Heating food-grade oils, however, decreases the available antioxidants, especially in the oils that cause bacterial death (EVO or coconut), and therefore, the concentration of the bacteria stored in the oils increases. The results may indicate that heating inulin causes interactions between the oil’s natural antioxidants and inulin. This results in a temporary encapsulation of the bacteria, which makes them difficult to count initially. However, after three months, the temporary protection is lost, and the bacteria is released and more easily counted, which explains the increased concentration after three months. Finally, LGG stored in different oils after treatment at 75° C. with inulin all showed all bacterial survival in the concentration range of ~10⁷ after 12 months compared with the control sample.

TABLE 2

Stored probiotic bacteria in different oils without and with initial oil heat treatment in the presence of inulin (In) at different temperatures after 3, 6, and 12 months at room temperature

| Heat Treatment | Sample | Initial | 90 Days Count | 180 Days Count | 360 Days Count |
|---|---|---|---|---|---|
| | | (CFU/mL) | (CFU/mL) | (CFU/mL) | (CFU/mL) |
| (A) RT+In | PBS Control | 1.12E+09 | 5.20E+06 | 1.80E+05 | 6.60E+03 |
| | Coconut Oil | 1.00E+09 | 6.80E+04 | 0 | 0 |
| | Sesame Oil | 1.02E+09 | 2.02E+08 | 9.20E+07 | 1.60E+06 |
| | Corn Oil | 1.12E+09 | 4.00E+06 | 4.00E+03 | 0 |
| | Extra Virgin Olive Oil | 1.24E+09 | 0 | 0 | 0 |
| | Cocoa Butter | 1.12E+09 | 1.10E+07 | 3.06E+05 | 18 |
| | Palm Oil | 1.04E+09 | 3.00E+07 | 3.60E+05 | 0 |
| | Hemp Oil | 1.00E+09 | 1.14E+07 | 1.48E+04 | 0 |
| | Canola Oil | 2.86E+09 | 2.40E+06 | 6.40E+03 | 0 |
| (B) 60° C.+In | PBS Control | 1.60E+06 | 1.54E+07 | 2.60E+07 | 6.40E+02 |
| | Coconut Oil | 8.00E+07 | 1.62E+08 | 2.60E+05 | 0 |
| | Sesame Oil | 8.20E+07 | 1.70E+09 | 1.70E+09 | 8.00E+07 |
| | Corn Oil | 8.00E+07 | 5.60E+07 | 1.40E+07 | 2.40E+06 |
| | Extra Virgin Olive Oil | 7.00E+07 | 6.80E+07 | 2.80E+05 | 0 |
| | Cocoa Butter | 8.60E+07 | 2.06E+08 | 1.06E+08 | 0 |
| | Palm Oil | 9.00E+07 | 2.20E+08 | 1.34E+08 | 1.20E+08 |
| | Hemp Oil | 9.60E+07 | 7.00E+08 | 1.62E+08 | 4.40E+07 |
| | Canola Oil | 8.40E+07 | 8.60E+07 | 2.80E+07 | 0 |
| (C) 75° C.+In | PBS Control | 5.40E+04 | 2.02E+07 | 3.20E+06 | 3.20E+02 |
| | Coconut Oil | 4.80E+07 | 2.54E+08 | 7.60E+07 | 7.60E+07 |
| | Sesame Oil | 6.00E+07 | 1.02E+08 | 6.80E+07 | 6.80E+07 |
| | Corn Oil | 2.02E+07 | 8.60E+08 | 1.62E+07 | 1.62E+07 |
| | Extra Virgin Olive Oil | 7.40E+05 | 6.60E+06 | 6.20E+06 | 6.20E+06 |
| | Cocoa Butter | 2.22E+07 | 2.18E+08 | 7.40E+07 | 7.40E+07 |
| | Palm Oil | 2.02E+07 | 2.36E+08 | 7.40E+07 | 7.40E+07 |
| | Hemp Oil | 5.00E+07 | 1.26E+08 | 2.20E+07 | 2.20E+07 |
| | Canola Oil | 1.50E+07 | 1.14E+08 | 7.80E+07 | 7.80E+07 |

### Growth Curves

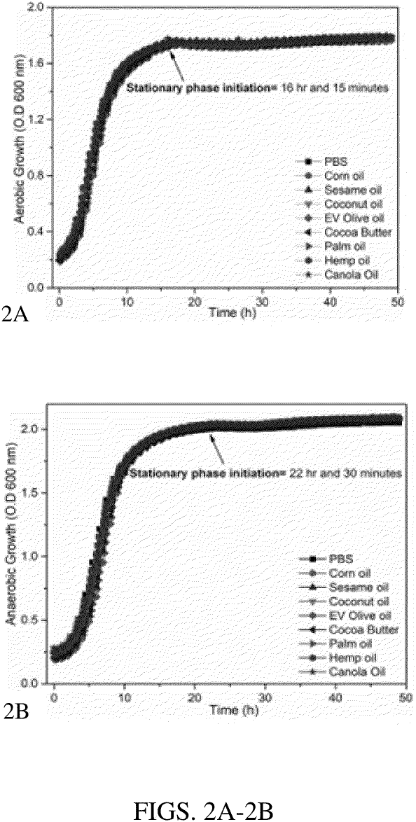

Since LGG is viable in both aerobic and anaerobic atmosphere, growth experiments under both conditions were performed. Based on the obtained curves depicted in aerobic and anaerobic conditions, no changes were observed in the growth behavior of the bacteria when compared to the control sample (FIGS. 2A and 2B). However, growth curves in anaerobic conditions required a longer time to reach the stationary phase when compared to aerobic conditions.

### RAPD PCR

To detect any mutations or significant changes in the structure of the stored bacteria, the RAPD PCR method was used for fast fingerprinting assessments.

For the test, 10 individual LGG colonies from each sample were screened by random amplified polymorphic DNA PCR (RAPD-PCR) using informative primers 1254, 1281, 1283. The PCR mixture consisted of 12.5 µL of Go Taq® Green Master Mix, 2X (Promega, Madison, USA), 1 µL of primer, 1 µL of samples, and 10.5 µL MQ water to a final volume of 25 µL. PCR was performed using DNA Thermal Cycler (Eppendorf Mastercycler® Gradient, Hamburg, Germany) according to Tomazi et al. procedure (T. Tomazi et al., PLOS ONE, 13, (2018) e0199561. However, an E. coli (JM109) sample was amplified as a positive control consisting of the same reaction mixture. All amplified samples were electrophoresed in a 1.5% agarose gel with 22 wells (previously stained with SYBR™ Safe 1:10,000) using TBE buffer at 150 V for 30 minutes. Images of gel were taken under ultraviolet light using a photo-documentation system. Band sizes were determined by comparison to TrackIt™ 100 bp DNA ladder (T. Tomazi et al., Ibid.).

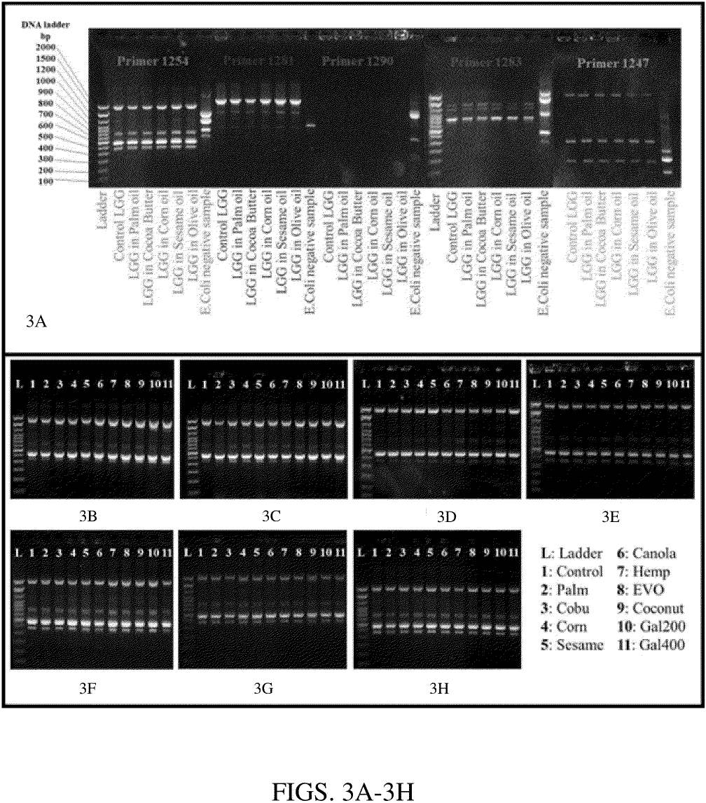

Initially, different RAPD primers were evaluated, including 1254, 1281, 1290, 1283, and 1247. The RAPD-PCR results of stored bacteria in representative oils after 6 months show the same band at each primer, therefore, 1254, 1281, and 1283 were chosen for the rest of the experiment because of the intensity of the bands (FIG. 3A).

Ten different colonies of each sample were selected and the RAPD-PCR were assessed using the three selected primers to observe the heterogeneity of the growth or possible changes in the bacterial structure. The results show no big changes in the samples after 6 months in different oils. The same results were further confirmed for 12 months of LGG storage in different oils and conditions (FIGS. 3B-3H). The sample conditions were denoted as without heat treatment (RT) (FIG. 3B), heat-treated samples (50, 60, and 75° C.) (FIGS. 3C, 3D, and 3E, respectively), prebiotic without heat treatment (RTI) (FIG. 3F), and inulin (prebiotic) with heat treatment (RTI-60 and RTI-75) (FIGS. 3G and 3H, respectively). All samples showed two strong bands at 2000 and 600 bp, while they also showed two weaker bands at 800 and 500 bp. The samples treated with gallic acid at 200 mg/L (Gal200) or 400 mg/L (Gal400) concentration also showed similar bands to the heat-treated and oil-stored samples in all three primers.

Since all of the oils show similar survival tests, growth curves, and RAPD-PCR, samples stored in palm oil were focused upon (because the sample is solid at room temperature and more uniformly dispersed) with the maximum heat treatments and samples kept in PBS with 200 mg/L gallic acid (Gal200) and 400 mg/L gallic acid Gal400. The palm oil samples are denoted as follows: LGG stored in palm oil without heat treatment—-Palm; LGG stored in palm oil with 75° C. heat treatment - Palm75; LGG stored in palm oil with inulin and without heat treatment - PalmI; and LGG stored in palm oil with inulin with 75° C. heat treatment - PalmI75.

### Motility Assay

All samples were grown overnight at 37° C. in MRS broth. Soft agar plates (1% tryptone, 0.5% NaCl, 0.25% agar) were prepared the day before assay. Then, 2 µl of the overnight culture was placed onto the center of each plate and incubated at 37° C. for at least 18 hours. Motility was quantified by measuring the diameter of the circular swarming area formed by the growing motile bacteria.

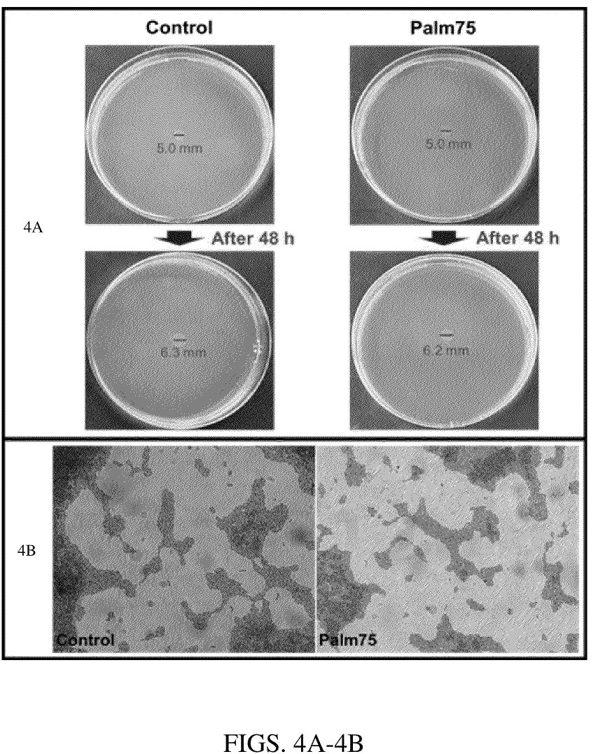

For a phenotypic readout, a motility test was performed. As well known, Lactobacillus bacteria strains are poorly motile or non-motile. The present results are consistent with this understanding. A slight increase in the diameter of the LGG movement was observed, as was a very small and poor shade of movement on the sloppy agar (Table 3 and FIG. 4A). The differences between the samples are statistically insignificant.

TABLE 3

Motility tests of samples after 48 hr

| | | |
|---|---|---|
| Samples | Initial (mm) | After 48 hr (mm) |
| PBS | 5.07 ± 0.17^{a} | 6.27 ± 0.34^{a} |
| Palm | 5.02 ± 0.14^{a} | 6.26 ± 0.26^{a} |
| Palm75 | 5.03 ± 0.33^{a} | 6.23 ± 0.25^{a} |
| PalmI | 5.00 ± 0.29^{a} | 6.20 ± 0.22^{a} |
| PalmI75 | 5.04 ± 0.34^{a} | 6.23 ± 0.24^{a} |
| Gal200 | 5.00± 0.08^{a} | 6.21 ± 0.22^{a} |
| Gal400 | 4.97 ± 0.39^{a} | 6.17 ± 0.21^{a} |

For all of the measurements collected on the same day, they are not showing significant difference (p < 0.05).

### Gram Staining

Gram staining was conducted by standard methods using a kit. Images were captured with an epifluorescence microscope equipped with a camera. To observe the morphology of the bacteria before and after storage, gram staining was used to see the bacteria under a microscope. All samples were identical and no differences were detected. The images show the rod-shaped LGG with no change in size or shape in the representative sample, Palm75, when compared to the control sample (FIG. 4B).

### Antimicrobial Sensitivity

Antimicrobial susceptibility or minimum inhibitory concentration (MIC) test was performed using the Sensititre® system COMPGP1F gram-positive systemic panel. The test used the Clinical and Laboratory Standards Institute (CLSI) guidelines for interpretation of MIC values. All of the isolates were examined for susceptibility to 23 antimicrobial agents included in the gram-positive panel of the National Antimicrobial Resistance Monitoring System (NARMS), including amikacin, ampicillin, augmentin, cefazolin, cefovecin, cefpodoxime, cephalothin, chloramphenicol, clindamycin, doxycycline, enrofloxacin, erythromycin, gentamicin, imipenem, marbofloxacin, minocycline, nitrofurantoin, oxacillin + 2% NaCl, penicillin, pradofloxacin, rifampin, tetracycline, trim/sulfa.

The sensitivity of the LGG stored in oil to antimicrobial agents was evaluated after heat treatment and storage. According to the antimicrobial sensitivity or Minimum inhibitory concentration (MIC) of the samples, all of the isolates were susceptible to augmentin, clindamycin, doxycycline, minocycline, erythromycin, and oxacillin + 2% NaCl. They are reported to have intermediate sensitivity to ampicillin, imipenem, and nitrofurantoin while showing resistance to cefazolin, cefpodoxime, and penicillin according to the CLSI guidelines. All samples showed similar functionality whether heat-treated, or with and without the presence of inulin. Moreover, the samples kept in PBS with gallic acid (antioxidant) with different concentrations also showed the same antimicrobial sensitivity.

### Cytokine Secretion

Samples were cultured from the frozen stock in MRS broth at 37° C. for 18 hours. After incubation, the bacteria were collected by centrifugation and washed three times with PBS. Then the bacteria were suspended in RPMI medium at ~10⁸ CFU/mL. The suspended bacteria in RPMI heat-inactivated at different temperatures from 65-100° C. for the various time between 30-120 min (results not shown), and finally, based on the inactivation and growth of the cells, 75° C. for 1 hour was chosen. The inactivated samples were stored at -80° C. until use. Cultured J774 cells were spread onto a 24-well flat-bottomed plate with 5 × 10⁵ cells/mL in each well. Afterward, 100 µl of the heat-inactivated sample was added to the wells. The supernatants were collected after 8, 16, and 24 hours incubation at 37° C. with 5% CO₂. The collected supernatant from samples was centrifuged to remove any cells or cell debris. The concentration of Interleuken-10 (IL-10) and TNF-α were assayed with commercial Elisa kits per manufacturer’s instructions, to observe the inflammatory and anti-inflammatory activities of samples before and after treatment. The results are reported as the mean and standard deviation of triplicate measurements.

The LGG exhibited two opposing properties at the same time. On one hand, it produces pro-inflammatory cytokines. Conversely, it produces Interleuken-10 (IL-10) which is an anti-inflammatory cytokine. IL-10 prevents phagocytic cells TNF-α production, by releasing antigen-presenting cells. In addition, it suppresses the expression of other co-stimulatory surface molecules and soluble cytokines. Therefore, the balance between inflammatory and anti-inflammatory cytokines is extremely important for host immunity. TNF-α results have been reported to be higher than the IL-10 results. However, in the present results, initial heat activation resulted in a modification in LGG that decreased TNF-α and increased IL-10.

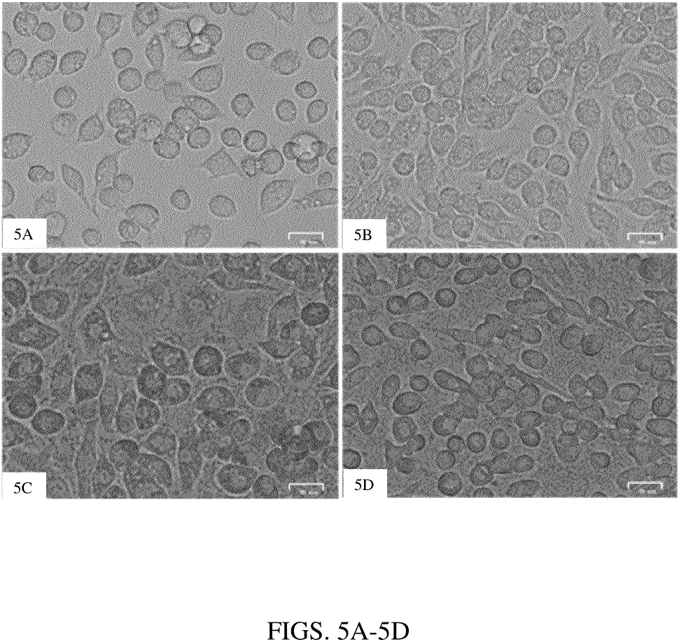

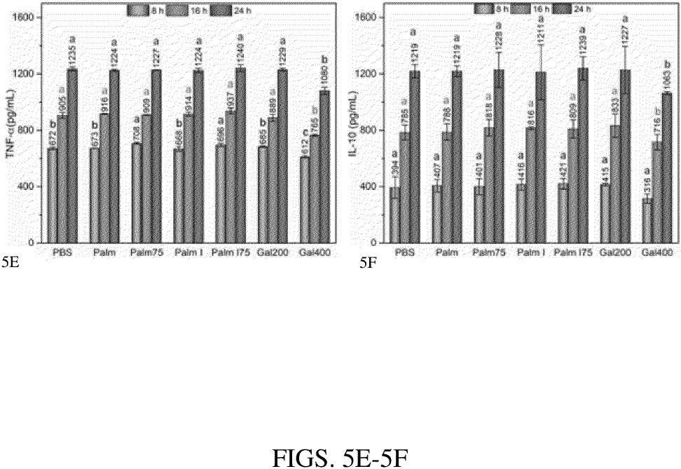

In this experiment, the ability of neat LGG and treated samples to induce cytokine secretion by macrophages was examined using the murine macrophage-like cell line J774. Initially, the number of heat-inactivated LGG was very low (FIG. 5A). Although the LGG bacteria are initially inactivated using heat treatment, they start to show growth after 8 hours (FIG. 5B) and reach a very high concentration after 16 hours and 24 hours (FIGS. 5C and 5D).

Pro-inflammatory cytokine TNF-α is one of the first cytokines that phagocytic cells can produce against pathogenic agents and bacteria. The TNF-α results indicate that all samples are similar and any differences are statistically insignificant when compared to the control sample (PBS), with one exception; Gal400 shows lower TNF-α results (FIG. 5E). These results confirm that even though no changes were detected in the macrophage-like J774 cell line test, cytokine production of the cells in the presence of Gal400 decreased due to the presence of higher antioxidant content. This demonstrates that other treatments, such as temperature and inulin, do not affect the inflammatory function of the LGG. An increase in TNF-α increases the cytotoxicity mediated by natural killer cells against tumors, which explains why LGG has anti-tumor effects in mice and humans.

In addition to the inflammatory properties, LGG is one of the first bacterial strains studied in oncology that shows anti-inflammatory properties by producing IL-10. This strain has the ability to restore gut microbial balance and has been studied for its effects in colon cancer, reduction of inflammation in Crohn’s disease, modification of intestinal flora, and production of secretory immunoglobulin A (IgA). The mechanism for the IL-10 secretion is still unclear. However, the lipopolysaccharide of gram-negative LGG and some other compounds may stimulate this anti-inflammatory cytokine response. The IL-10 cytokine assay results indicate that regardless of the treatment, all samples show similar results except Gal400 (FIG. 5F). The foregoing results indicate that higher antioxidant concentrations reduce the ability of the LGG to force the cells to produce cytokine.

### Genome Sequencing and Single Nucleotide Polymorphism (SNP)s

QIAamp DNA Mini Kit was used to extract genomicDNA according to the manufacturer’s instructions. The concentration of the extracted DNA was measured using a Nanodrop ND-100 UV-vis spectrophotometer. Genomic DNA sequencing was completed by the Biotech Genome facility of Cornell University.

Trimmomatic (v0.36) was used to trim adapter sequences and low quality bases in Illumina paired-end reads with parameters “ILLUMINACLIP:TruSeq3-PE-2.fa:2:30:10:1:TRUE SLIDINGWINDOW:4:20 LEADING:3 TRAILING:3 MINLEN:40”. The cleaned read pairs were aligned to the Lactobacillus rhamnosus GG genome (GenBank Accession Number: FM179322) using BWA-MEM (v0.7.16a-r1181) with default parameters. Picard (v2.24.0) was used to mark duplicated read pairs with parameter “OPTICAL_DUPLICATE_PIXEL_DISTANCE=250”. GVCF file for each sample was generated using the HaplotypeCaller tool in the GATK package with parameters “—-genotyping_mode DISCOVERY —max_alternate_alleles 3 —-read_filter OverclippedRead”, followed by joint single nucleotide polymorphism (SNP) calling on all samples with the Genotype GVCFs tool in GATK with default parameters. Hard filtering was applied to the raw SNP set using the Variant Filtration tool in GATK with parameters ‘QD<2.0 || FS>60.0 || MQ<40.0 || MQRankSum <-12.5 || ReadPosRankSum <-8.0’. Structural variants (SVs) were called from the alignment files with LUMPY using the Smoove wrapper (v0.2.6) with default parameters. SVs without split read support were excluded. All identified single nucleotide polymorphisms (SNPs) and SVs were manually checked using an integrative genomics viewer (IGV) (J. T. Robinson et al., Nat. Biotechnol. 29, 24-26, 2011).

Genomic sequence analysis against the known sequences of Lactobacillus rhamnosus GG in Genbank (FM179322) (M. Kankainen et al., Proc. Natl. Acad. Sci. 106 (2009) 17193-17198) was performed. Some minor changes were observed in 6 single nucleotide polymorphisms (SNPs) identified among the 7 samples sequenced. These SNPs were manually confirmed as significant and real. These SNPs were found to alter 6 protein sequences as the results of codon changes (Table 4).

By comparing all samples to the Control (PBS), the number of the SNPs were found to be different depending on sample treatment. Storing LGG for a year in oil was found to have almost no effect (palm). The addition of prebiotics, heat treatment (75° C.), and the combination of the two caused only a single SNP. However, exposing the bacteria to gallic acid had a strong negative impact. Specifically, when the concentration of gallic acid was increased, the number of SNPs increased. For instance, Gal200 shows 3 SNPs, while the Gal400 shows the highest number of SNPs with 5 SNPs. The reason for the SNPs detected in these sequenced samples may not be solely due to the treatments. Rather, it may be the result of the heterogeneity of the bacterial population as each individual sample is derived from a single colony on a plate containing heterogeneous LGG. This phenomenon is also observed in other types of bacteria (K. M. Davis, Bioessays. 38 (2016) 782-790).

TABLE 4

The list of the affected protein sequences in this study

| No | Protein | Role |
|---|---|---|
| 1 | 6-phospho-alpha-glucosidase | Participate in glycolysis/gluconeogenesis, hydrolyzing O— or S-glucosyl compounds |
| 2 | ABC transporter ATP-binding protein | A type of active transporters, functioning as an importer and exporter |
| 3 | Ser-Ala-175 repeat protein | Serine and alanine-rich surface protein repeat, about 175 amino acids long, occurs in many surface proteins of some lactobacillus strains, especially in Lactobacillus rhamnosus |
| 4 | DeoR/GlpR transcriptional regulator | GlpR is a DeoR type transcription regulator, suppressing gene expression involved in glucose and fructose metabolism when growing in glycerol. |
| 5 | histidine phosphatase family protein | A superfamily of phosphatase/mutase, participating in different pathways. |
| 6 | CamS family sex pheromone protein | Regulates conjugation and cell-cell signaling |

### Metabolic Studies

For metabolite analysis, the supernatant medium of bacteria during the growth (500 µL) was collected after 8, 16, and 24 hours culture time at 37° C. and stored at -80° C. for further analysis. Samples were injected into an HPLC connected to a mass spectrometer with an ESI ion source. The solution of 75% MQ water and 25% acetonitrile with 0.1% formic acid at a flow rate of 0.5 mL/min was used as a mobile phase. A 2.7 µm C18 nonpolar was used as the HPLC column and was run at ambient temperature. The injection volume was 10 µL and the injections were repeated three times for each sample. Same ion source parameters were used for negative and positive ion modes. The total run time for all samples and scan types was 30 minutes. The capillary temperature was adjusted to 350° C. Sheath gas and auxiliary flow rate were set at 50 and 15 au, respectively. Finally, the spray, tube lens, and capillary voltages were adjusted at 4 kV, 125 V, and 41 V, respectively. The samples were initially run in the first stage of mass spectrometry (parent mass, MS¹) in a normal scan range and resolution settings (50-2000 m/z) to verify the presence of the possible metabolite products. Then, to obtain the best transition ions, the selective reaction monitoring (SRM) analysis of detected metabolite in the second stage of mass spectrometry (MS²) was carried out. After optimizing the conditions for SRM, samples were analyzed in triplicates and the metabolite was quantified using the area under the peak. To normalize the results between samples, the metabolites are reported as the percent total of all the metabolites.

To better understand the effect of heat, inulin, or antioxidants on LGG, the metabolites secreted in the MRS medium of representative samples were analyzed using liquid chromatography/mass spectrometry (LCMS). The LCMS spectra indicated the presence of the commonly reported metabolites of Lactobacillus. The results have been subtracted from the medium, and only the metabolite secretion that has been produced (positive results) after 24 hour has been reported (Table 5). The amino acid secretions, such as arginine, lysine, leucine, valine, methionine and tryptophan, during this time were substantially identical, and the remaining glucose content indicated that the MRS medium had enough nutrients for the 24 hour culture time. The low and relatively unchanged content of glycerol, which is a component of bacterial phospholipid membrane, suggests a healthy bacterial growth in all of the groups, although the Gal400 shows a slightly lower value, as predicted based on the previous results.

One of the most important functions of the Lactobacillus probiotic, such as LGG, is that they have antioxidant properties and can withstand low pH. The increase in acid resistance is due to the restoration of the optimum intracellular pH by using the arginine and production of NH₃, and the LGG in all samples with different treatment shows nearly the same level of arginine. LGG produces a host of antioxidants, and these secretions can reduce bacterial cell damage by reacting with reactive oxygen species (ROS) and acts as an oxygen scavenger. All samples, except Gal400, exhibited a nearly constant level of antioxidant, such as ascorbate, 3-phenyl lactic acid, lactic acid indole propenamide, flavone and glutathione, which can be due to the low content of ROS present in the medium during the growth. This suggests that there is minimum cell damage during heat treatment and inulin exposures and during later bacterial growth. These results show that antioxidant secretions are quite similar. Another important function of the probiotic LGG is that they should promote digestive health and decrease the inflammation and risk of diseases; the constant secretion of acetoin, ferulic acid, short-chain fatty acids such as butyric acid, creatine, and Vitamin B₁₂ shows that heat and inulin exposures did not negatively impact digestive health. However, similar to previous results, Gal400 has slightly decreased the content of these secretions.

This experiment highlighted the robustness of LGG in oil regardless of heat or inulin treatment. All of the expected metabolites produced by the LGG are present and in similar concentrations regardless of treatment. Only those samples stored in a high content of antioxidant gallic acid (Gal400) show any measurable difference. The lower secretion percentage of metabolites for the Gal400 sample confirms that LGG becomes weaker in the production of metabolites in the presence of higher concentrations of antioxidants. This may be because LGG already produces enough antioxidants to protect itself, and the addition of external antioxidants has an adverse effect on its metabolite secretion.

TABLE 5

Metabolites secreted into the medium (% total signal)

| Compound | PBS | Palm | Palm75 | PalmI | PalmI75 | Gal200 | Gal400 | Medium |
|---|---|---|---|---|---|---|---|---|
| Arginine | 0.11 | 0.12 | 0.11 | 0.12 | 0.11 | 0.10 | 0.07 | 2.52 |
| Ascorbate | 4.15 | 4.18 | 4.16 | 4.17 | 4.14 | 4.12 | 4.02 | 3.26 |
| Acetoin | 0.34 | 0.35 | 0.34 | 0.35 | 0.34 | 0.33 | 0.28 | 0.78 |
| Butyric acid | 0.67 | 0.66 | 0.65 | 0.67 | 0.65 | 0.64 | 0.61 | 0 |
| Creatine* | 0.11 | 0.11 | 0.11 | 0.11 | 0.10 | 0.10 | 0.08 | 0.06 |
| Diacetyl | 0.31 | 0.31 | 0.30 | 0.32 | 0.30 | 0.29 | 0.24 | 0.65 |
| Flavone | 1.44 | 1.46 | 1.44 | 1.45 | 1.43 | 1.42 | 1.38 | 0.67 |
| Glycerol | 0.96 | 0.95 | 0.95 | 0.96 | 0.95 | 0.95 | 0.93 | 1.34 |
| Glucose | 0.51 | 0.51 | 0.51 | 0.51 | 0.52 | 0.51 | 0.52 | 1.28 |
| Glutathione | 0.19 | 0.18 | 0.18 | 0.19 | 0.17 | 0.17 | 0.16 | 1.59 |
| 5-hydroxyl ferulic acid | 1.49 | 1.50 | 1.48 | 1.49 | 1.47 | 1.46 | 1.39 | 3.19 |
| 2-hydroxyl indole-3-propanamide | 0.36 | 0.36 | 0.35 | 0.36 | 0.35 | 0.34 | 0.30 | 3.11 |
| (2-Hydroxy-3-phenylpropanoic acid) | 5.34 | 5.38 | 5.35 | 5.36 | 5.34 | 5.33 | 5.26 | 3.68 |
| Lysine* | 0.09 | 0.10 | 0.09 | 0.09 | 0.09 | 0.09 | 0.08 | 0.01 |
| Leucine | 21.94 | 21.96 | 21.95 | 21.95 | 21.93 | 21.92 | 21.84 | 20.62 |
| Lactic acid | 1.22 | 1.23 | 1.22 | 1.23 | 1.22 | 1.22 | 0.95 | 0.00 |
| Methionine | 1.79 | 1.78 | 1.77 | 1.79 | 1.77 | 1.76 | 1.69 | 1.78 |
| Tryptophan | 1.75 | 1.75 | 1.76 | 1.75 | 1.74 | 1.74 | 1.71 | 0.63 |
| Valine | 4.76 | 4.74 | 4.74 | 4.75 | 4.74 | 4.73 | 4.68 | 2.06 |
| Vitamin B12 | 3.15 | 3.18 | 3.17 | 3.18 | 3.15 | 3.14 | 3.05 | 1.13 |

* Indicates metabolite measured in negative ion mode (all other compounds measured in positive ion mode). The medium results have been subtracted from the obtained sample results

### Conclusion

Several food-grade oils with various amounts of polyunsaturated and monounsaturated fat were used to preserve the probiotic bacteria for a period of 12 months at room temperature. The bacteria were treated by different methods, including exposure to the antioxidant gallic acid, different heat treatments, the addition of the prebiotic inulin, and a combination of heat and inulin. The presently described method advantageously permits preservation of probiotic bacteria outside of the refrigerator, and more specifically, at room temperature for at least 12 months at a good survival rate when compared to the initial concentration. The RAPD-PCR, bioscreen growth, motility experiments, gram staining microscopy images, antimicrobial experiments, inflammatory and anti-inflammatory cytokine induction experiments, metabolite secretion, and DNA genome sequencing results confirmed that no mutation occurred during the treatment and in the 12-months during storage. The addition of a higher concentration of antioxidants, however, had a negative effect on the survivability of the bacteria and its metabolite secretion, which resulted in weaker performance of the bacteria in the cytokine induction studies. Overall, in order to use food grade oils for preserving LGG, the antioxidant content should be as low as possible. These bacteria already produce the required concentration of antioxidant during their growth for their protection against ROS, and more than what they produce can decrease their functionality.

While there have been shown and described what are at present considered the preferred embodiments of the invention, those skilled in the art may make various changes and modifications which remain within the scope of the invention defined by the appended claims and the examples below.

In Example 1, the present concepts include a shelf-stable probiotic composition comprising a lyophilized probiotic dispersed in a food grade oil, wherein the probiotic in the shelf-stable probiotic composition remains viable for at least 12 months at room temperature.

In Example 2, which comprises the composition of Example 1, the probiotic in the shelf-stable probiotic composition remains viable by maintaining a CFU/mL of at least 20%, for at least 12 months at room temperature, relative to a starting CFU/mL of the probiotic when first dispersed in the food grade oil.

In Example 3, which comprises the composition of Example 1 or Example 2, the probiotic in the shelf-stable probiotic composition exhibits substantially same metabolic activity with substantially no genetic mutation after 12 months of storage at room temperature.

In Example 4, which comprises the composition of any one of Examples 1-3, the food grade oil in the shelf-stable probiotic composition is heat-treated food grade oil having a lower percentage of active phenolic antioxidant than in the same food grade oil not heat treated.

In Example 5, which comprises the composition of any one of Examples 1-4, the probiotic is selected from the group consisting of Lactobacillus, Bifidobacteria, Escherichia, Bacillus, Streptococcus, Saccharomyces, and combinations thereof.

In Example 6, which comprises the composition of any one of Examples 1-5, the shelf-stable probiotic composition further comprises an oligosaccharide dispersed in the food grade oil.

In Example 7, which comprises the composition of Example 6, the oligosaccharide is a fructooligosaccharide or galactooligosaccharide.

In Example 8, which comprises the composition of Example 6, wherein the oligosaccharide comprises inulin.

In Example 9, which comprises the composition of any one of Examples 1-8, the shelf-stable probiotic composition is prepared by a method comprising: (i) dispersing a probiotic in a heat-treated food grade oil to form a probiotic dispersion; (ii) heating said probiotic dispersion to a temperature in a range of 30-80° C. for at least 1 minute; and (iii) cooling the probiotic dispersion to room temperature to result in the shelf-stable probiotic composition.

In Example 10, which comprises the composition of Example 9, the shelf-stable probiotic composition is prepared by a method further comprising, before step (i), preparing said heat-treated food grade oil by heating food grade oil, without probiotic dispersed therein, at 30-80° C. for at least 15 minutes.

In Example 11, which comprises the composition of Example 9 or Example 10, step (iii) comprises non-active gradual cooling of the probiotic dispersion to room temperature.

In Example 12, which comprises the composition of any of Examples 9-11, step (i) further comprises dispersing an oligosaccharide in the food grade oil along with the probiotic.

In Example 13, the present concepts include a method for preparing a shelf-stable probiotic composition, the method comprising: (i) dispersing a probiotic in a heat-treated food grade oil to form a probiotic dispersion; (ii) heating said probiotic dispersion to a temperature in a range of 30-80° C. for at least 1 minute; and (iii) cooling the probiotic dispersion to room temperature to result in the shelf-stable probiotic composition.

In Example 14, further to the acts in the method of Example 13, the method further comprises, before step (i), preparing said heat-treated food grade oil by heating food grade oil, without probiotic dispersed therein, at 30-80° C. for at least 15 minutes.

In Example 15, further to the method of Example 13 or Example 14, step (iii) comprises non-active gradual cooling of the probiotic dispersion to room temperature.

In Example 16, further to the method of any one of Examples 13-15, step (i) further comprises dispersing an oligosaccharide in the food grade oil along with the probiotic to result in the shelf-stable probiotic composition comprising the oligosaccharide and probiotic dispersed in the food grade oil.

In Example 17, further to the method of Example 16, the oligosaccharide is a fructooligosaccharide or galactooligosaccharide.

In Example 18, further to the method of Example 16, the oligosaccharide comprises inulin.

In Example 19, further to the method of any one of Examples 13-18, the probiotic in the shelf-stable probiotic composition remains viable for at least 12 months at room temperature.

In Example 20, further to the method of any one of Examples 13-19, the probiotic in the shelf-stable probiotic composition remains viable by maintaining a CFU/mL of at least 20%, for at least 12 months at room temperature, relative to a starting CFU/mL of the probiotic when first dispersed in the food grade oil.

In Example 21, further to the method of any one of Examples 13-20, the probiotic in the shelf-stable probiotic composition exhibits substantially same metabolic activity with substantially no genetic mutation after 12 months of storage at room temperature.

In Example 22, further to the method of any one of Examples 13-21, the food grade oil, after being heat treated in step (ii), has a lower percentage of active phenolic antioxidant than in the same food grade oil not heat treated.

In Example 23, further to the method of any one of Examples 13-22, the probiotic is selected from the group consisting of Lactobacillus, Bifidobacteria, Escherichia, Bacillus, Streptococcus, Saccharomyces, and combinations thereof.

In Example 24, the present concepts include a method for preparing a shelf-stable probiotic composition, the method comprising: heating food grade oil at 30-80° C. for at least 15 minutes; dispersing a probiotic in the heated food grade oil to form a probiotic dispersion; incubating the probiotic dispersion at a temperature of 30-80° C. for at least 1 minute; and cooling the probiotic dispersion to room temperature to result in the shelf-stable probiotic composition.

In Example 25, the method of Example 24 further includes, as to the act of cooling the probiotic dispersion to room temperature, non-active gradual cooling of the probiotic dispersion to room temperature.

In Example 26, further to the method according to any one of Examples 24 and 25, the method comprises dispersing an oligosaccharide in the food grade oil along with the probiotic to result in the shelf-stable probiotic composition comprising the oligosaccharide and probiotic dispersed in the food grade oil.

In Example 27, further to the method according to any one of Examples 24-26, the oligosaccharide is a fructooligosaccharide or galactooligosaccharide.

In Example 28, further to the method according to any one of Examples 24-26, the oligosaccharide comprises inulin.

In Example 29, further to the method according to any one of Examples 24-28, the probiotic is selected from the group consisting of Lactobacillus, Bifidobacteria, Escherichia, Bacillus, Streptococcus, Saccharomyces, and combinations thereof.

What is claimed is:

1. A shelf-stable probiotic composition comprising a lyophilized probiotic dispersed in a food grade oil, wherein the probiotic in the shelf-stable probiotic composition remains viable for at least 12 months at room temperature.

2. The composition of claim 1, wherein the probiotic in the shelf-stable probiotic composition remains viable by maintaining a CFU/mL of at least 20%, for at least 12 months at room temperature, relative to a starting CFU/mL of the probiotic when first dispersed in the food grade oil.

3. The composition according to claim 1, wherein the probiotic in the shelf-stable probiotic composition exhibits substantially same metabolic activity with substantially no genetic mutation after 12 months of storage at room temperature.

4. The composition according to claim 1, wherein the food grade oil in the shelf-stable probiotic composition is heat-treated food grade oil having a lower percentage of active phenolic antioxidant than in the same food grade oil not heat treated.

5. The composition according to claim 1, wherein the probiotic is selected from the group consisting of Lactobacillus, Bifidobacteria, Escherichia, Bacillus, Streptococcus, Saccharomyces, and combinations thereof.

6. The composition according to claim 1, wherein the shelf-stable probiotic composition further comprises an oligosaccharide dispersed in the food grade oil.

7. The composition of claim 6, wherein the oligosaccharide is a fructooligosaccharide or galactooligosaccharide, or wherein the oligosaccharide comprises inulin.

8. The composition according to claim 1, wherein the shelf-stable probiotic composition is prepared by a method comprising:
(i) dispersing a probiotic in a heat-treated food grade oil to form a probiotic dispersion;
(ii) heating said probiotic dispersion to a temperature in a range of 30-80° C. for at least 1 minute; and
(iii) cooling the probiotic dispersion to room temperature to result in the shelf-stable probiotic composition.

9. The composition of claim 8, further comprising, before step (i), preparing said heat-treated food grade oil by heating food grade oil, without probiotic dispersed therein, at 30-80° C. for at least 15 minutes.

10. The composition of claim 8, wherein step (iii) comprises non-active gradual cooling of the probiotic dispersion to room temperature.

11. The composition of claim 8, wherein step (i) further comprises dispersing an oligosaccharide in the food grade oil along with the probiotic.

12. A method for preparing a shelf-stable probiotic composition, the method comprising:
dispersing a probiotic in a heat-treated food grade oil to form a probiotic dispersion;
heating said probiotic dispersion to a temperature in a range of 30-80° C. for at least 1 minute; and
cooling the probiotic dispersion to room temperature to result in the shelf-stable probiotic composition.

13. The method of claim 12, further comprising, before the act of dispersing the probiotic in a heat-treated food grade oil, preparing said heat-treated food grade oil by heating food grade oil, without probiotic dispersed therein, at 30-80° C. for at least 15 minutes.

14. The method according to claim 12, wherein the act of cooling the probiotic dispersion to room temperature comprises non-active gradual cooling of the probiotic dispersion to room temperature.

15. The method according to claim 12, wherein the act of dispersing the probiotic in a heat-treated food grade oil further comprises dispersing an oligosaccharide in the food grade oil along with the probiotic to result in the shelf-stable probiotic composition comprising the oligosaccharide and probiotic dispersed in the food grade oil.

16. The method of claim 15, wherein the oligosaccharide is a fructooligosaccharide or galactooligosaccharide, or wherein the oligosaccharide comprises inulin.

17. The method according to claim 12, wherein the probiotic in the shelf-stable probiotic composition remains viable for at least 12 months at room temperature.

18. The method according to claim 12, wherein the probiotic in the shelf-stable probiotic composition remains viable by maintaining a CFU/mL of at least 20%, for at least 12 months at room temperature, relative to a starting CFU/mL of the probiotic when first dispersed in the food grade oil.

19. The method according to claim 12, wherein the probiotic in the shelf-stable probiotic composition exhibits substantially same metabolic activity with substantially no genetic mutation after 12 months of storage at room temperature.

20. The method according to claim 12, wherein the food grade oil, after the act of heating the probiotic dispersion, has a lower percentage of active phenolic antioxidant than in the same food grade oil not heat treated.

21. The method according to claim 12, wherein the probiotic is selected from the group consisting of Lactobacillus, Bifidobacteria, Escherichia, Bacillus, Streptococcus, Saccharomyces, and combinations thereof.
